(19) United States
(12) Patent Application Publication
(10) Pub. No.: US 2009/0063186 A1
(43) Pub. Date: Mar. 5, 2009

(54) FOREGROUND MULTI USER, MULTI PATIENT WORKFLOW ON RAD SYSTEMS

(76) Inventor: Rajeev R. Marar, Waukesha, WI (US)

Correspondence Address: RAMIREZ & SMITH, PO BOX 341179, AUSTIN, TX, 78734, US

(21) Appl. No.: 11/850,547

(22) Filed: Sep. 5, 2007

(51) Int. Cl. G06Q 50/00

(52) U.S. Cl. 705/2

(57) ABSTRACT

Systems, methods and apparatus are provided for acquiring medical images through a flexible workflow process. The present application further provides a modular workflow having an operator interface that may be tailored and made unique for each individual application. The imaging system supports multiple user stations or terminals where multiple users can log into. The system has the capability to track and capture audit data for each user. In a multi terminal environment a terminal can perform acquisition of medical images, another terminal can be accessing medical images from a database and performing analysis of retrieved images. Additionally, the terminals can be assigned different roles based on whether is performing image acquisition, image retrieval, or foreground application processing.

### FIELD OF THE INVENTION

This invention relates generally to the field of non-invasive imaging, including medical imaging. More specifically, the present invention relates to a workflow for automated scheduling of procedures and resources in such environments.

### BACKGROUND OF THE INVENTION

The integration of different healthcare systems has increased the speed of information flow, however the workflow process is still not highly efficient. The conventional workflows do not allow for a method of information flow that can minimize undue delays involved in scheduling and analyzing the results of all requisite exams performed on the patient. At best the current workflow offer multiple imaging positions such as table, wall stand, flying detector. However, the conventional workflow usually allows only dealing with image data of a singe patient. With needs for faster throughput in facilities having more than 10 to 20 patients per hour, the single patient workflow would become a bottleneck. This bottleneck can be avoided or limited if a suitable workflow is available.

For the reasons stated above, and for other reasons stated below which will become apparent to those skilled in the art upon reading and understanding the present specification, there is a need in the art for flexible workflow processing. There is also a need for an imaging system that supports multi users and multi patients.

### BRIEF DESCRIPTION OF THE INVENTION

The above-mentioned shortcomings, disadvantages and problems are addressed herein, which will be understood by reading and studying the following specification.

The present invention is directed to a method and system for a flexible workflow process for acquiring medical images and for medical imaging data processing applications. The present application further provides a modular workflow having an operator interface that may be tailored and made unique for each individual application. The system supports multiple user stations or terminals with an operator interface where multiple users can log into. Further, the system has the capability to track and capture audit data for each user. In a multi terminal environment a terminal can perform acquisition of medical images, another terminal can be accessing medical images from a database and performing analysis of retrieved images. Additionally, the terminals can be assigned different roles based on whether is performing image acquisition, image retrieval, or foreground application processing.

In one aspect, an imaging system for flexible workflow processing is disclosed with a plurality of systems having user interface; the systems able to perform image acquisition, foreground applications processing, coupling to a network so as to access information from a picture archiving communication system, a hospital information system, and a record information system. The flexible workflow imaging system associates auxiliary imaging equipment to those systems that are performing image acquisition.

In another aspect, the flexible workflow imaging system partitions the room holding the auxiliary image equipment into sections that are independent of each other.

In yet another aspect, the flexible workflow imaging system creates an imaging chain consisting of the auxiliary imaging equipment including the section of the room where the equipment is located.

In still another aspect, the hospital information system sends a patient list with imaging prescription foe each patient on the list. The user through the interface can select or add the patient to be imaged.

In a further aspect, the flexible workflow imaging system tracks and captures audit data for each of the first terminal and the one or more additional terminal and users of the first terminal and the one or more additional terminal.

In yet a further aspect, system for flexible workflow processing employs a processor, a storage device coupled to the processor, and software means operative on the processor for: configuring a first terminal with a user interface to perform one or more image acquisition, foreground application processing, and coupling to a network; configuring one or more additional terminal with a user interface to perform one or more image acquisition, foreground application processing, and coupling to said network; and assigning auxiliary imaging equipment to said first terminal or additional terminal for performing image acquisition.

In still yet a further aspect, the processor at the system for flexible workflow processing tracks and captures audit data for each of the first terminal and the one or more additional terminal and users of the first terminal and the one or more additional terminal.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a diagram illustrating a system-level overview of a workstation supporting multiple systems in accordance to an embodiment;

FIG. 2 is a diagram illustrating an imaging system coupled to a network in accordance to an embodiment;

FIG. 3 is a diagram illustrating a room holding auxiliary image equipment in accordance to an embodiment.

FIG. 4 is a flowchart of a method for configuring a plurality of systems according to an embodiment;

FIG. 5 is a diagram of an imaging chain data structure for use in an implementation in accordance to an embodiment.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

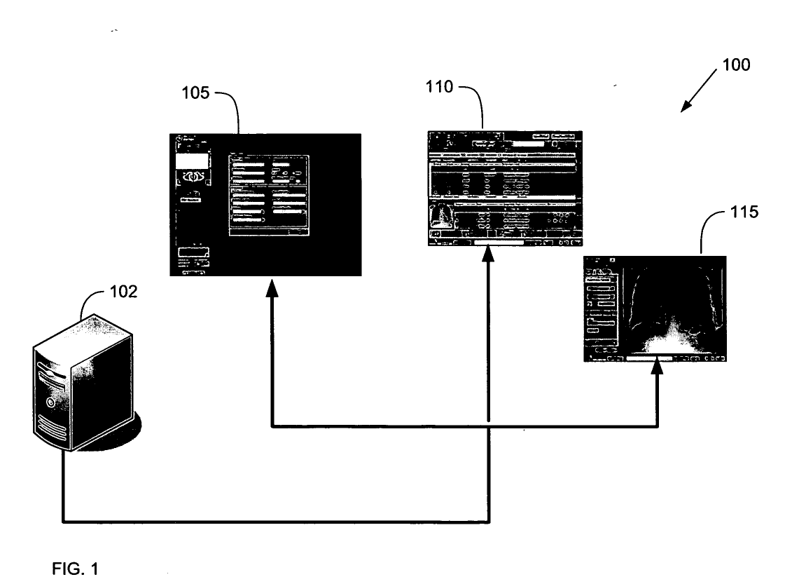

FIG. 1 illustrates an exemplary diagram of a system 100 for flexible workflow processing in accordance with a possible embodiment of the invention. FIG. 1 generally identifies workstation 102, an acquisition terminal 105, a foreground application terminal 110, and image review terminal 115. System 100 solves the need in the art for flexible workflow processing.

System 100 includes workstation 102 having software for configuring the terminals (105, 110, 115) to perform the role of image acquisition, foreground application processing, and coupling to a network for accessing resources. The users can perform review tasks such as archiving, deleting, managing the image data in the terminals, and any other function within the functionality of the terminal. Additionally, workstation 102 contains an audit mechanism that captures or receives access requests for logging and analysis purposes such as security, transaction audit gathering and trending. Security usage identifies undesirable transactions for possible blocking the selected transactions. Trending focuses on suspect usage patterns and highlights or optionally blocks such transactions. Audit data gathering usage collects data required for regulatory compliance such as identifying access trails to sensitive data. Such audit data gathering includes tracking metadata changes resulting from administrative metadata commands, and tracking or correlating such changes with a tag label.

Workstation 102, and terminals 105-110 have computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Workstation 102 and terminals 105-115 include a processor, commercially available from Intel, Motorola, Cyrix and others, random-access memory (RAM), read-only memory (ROM), and one or more mass storage devices. The memory and mass storage devices are types of computer-accessible media. Workstation 102 and terminals 105-115 can be communicatively connected to the Internet via a communication devices that are well known within the art. The workstation 102 and terminals 105-115 communication are connected through a network device 260 such an Ethernet® or similar hardware network card connected to a local-area network (LAN) that itself is connected to the Internet via what is known in the art as a “direct connection” (e.g., T1 line, etc.).

A user enters commands and information into the workstation and terminal through input devices such as a keyboard or a pointing device. The keyboard permits entry of textual information, as known within the art, and embodiments are not limited to any particular type of keyboard. Pointing device permits the control of the screen pointer provided by a graphical user interface (GUI) of operating systems such as versions of Microsoft Windows®. Embodiments are not limited to any particular pointing device. Such pointing devices include mice, touch pads, trackballs, remote controls and point sticks. Other input devices (not shown) can include a microphone, joystick, game pad, satellite dish, scanner, or the like. A display device permits the display of information, including computer, video and other information, for viewing by a user of the computer. Embodiments are not limited to any particular display device. Such display devices include cathode ray tube (CRT) displays (monitors), as well as flat panel displays such as liquid crystal displays (LCD's). In addition to a monitor, computers typically include other peripheral input/output devices such as printers (not shown). Embodiments of workstation 102 and terminals 105-115 are not limited to any type of computer. Workstation 102 and terminals 105-115 comprise a PC-compatible computer, a MacOS®-compatible computer, a Linux®-compatible computer, or a UNIX®-compatible computer. The construction and operation of such computers are well known within the art.

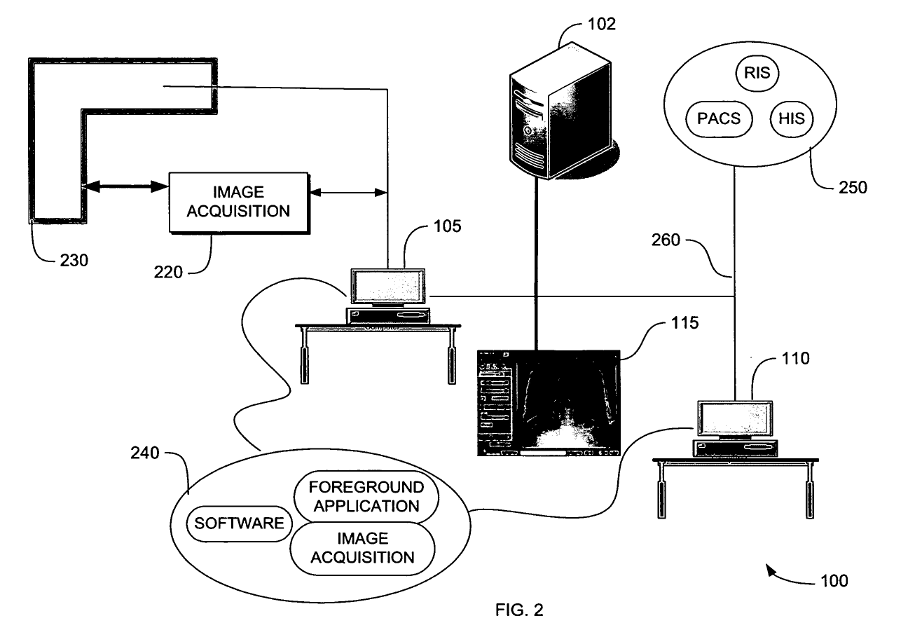

FIG. 2 is an illustration of the operation of an imaging system 200 showing a first terminal 105, second terminal 110, and third terminal 115 all coupled to a network 260. The network couples the terminals (105, 110, 115) to resource 250 consisting radiology information system (RIS), picture archiving and communication system (PACS), and hospital information system (HIS). The terminals may be hardwired to the network 260 or may communicate with it wirelessly. In this manner, the terminals can communicate with each other or computers or remote means, which are connected to the network 260, enabling images in the PACS database and patient records in the HIS database to be forwarded to the appropriate personnel and displayed on associated monitor of the terminal.

Auxiliary imaging equipment is maintained in room 230, the equipment can include CT scanner, x-ray tube, tables, wall stands, an array of radiation detectors and x-ray tubes, and overhead tube suspension.

Typically, the imaging operator or user performs a scan using a terminal such as terminal 105 loaded with software 240 that permits the terminal to manipulate the auxiliary imaging equipment through image acquisition hardware 220 and network 260. Diagnostic data from the equipment is reconstructed by a reconstruction processor (not shown) into electronic image representations which are stored in a diagnostic image memory (not shown). The reconstruction processor may be incorporated into any of the terminals (105, 110, 115), the auxiliary imaging equipment, or may be a shared resource among a plurality of imaging equipment and workstation 102. Other hardware at image acquisition 220 can include diagnostic image memory for storing a three-dimensional image representation of an examined region of a patient, a video processor for converting selected portions of the three-dimensional image representation into appropriate format for display on a video monitor. The operator controls the imaging process, production and display of images by using a user interface screen or screens which are incorporated into the terminals (105, 110, 115) and displayed on the monitor to guide the operator through the imaging process. An interface r processor controls the user interface. The operator uses an operator input device, such as a keyboard or mouse to interact with an applications database 250 by navigating the user interface screen. The user interface screen can include a plurality of icons and buttons to navigate through the interface screen and to control scanning workflow.

PACS database in application database 250 is a repository, and may include various types of storage devices and databases for receiving and storing the medical information, including images from all exams that are performed at acquisition modality. The PACS database can be a central repository, which contains medical information and images from a number of acquisition modalities or can be in the form of a number of different repositories, each containing medical information specific to an acquisition modality. Moreover, any suitable type of repository may be employed for the present purposes, including dedicated memory devices, shared memory devices, magnetic and optical storage technologies, and so forth.

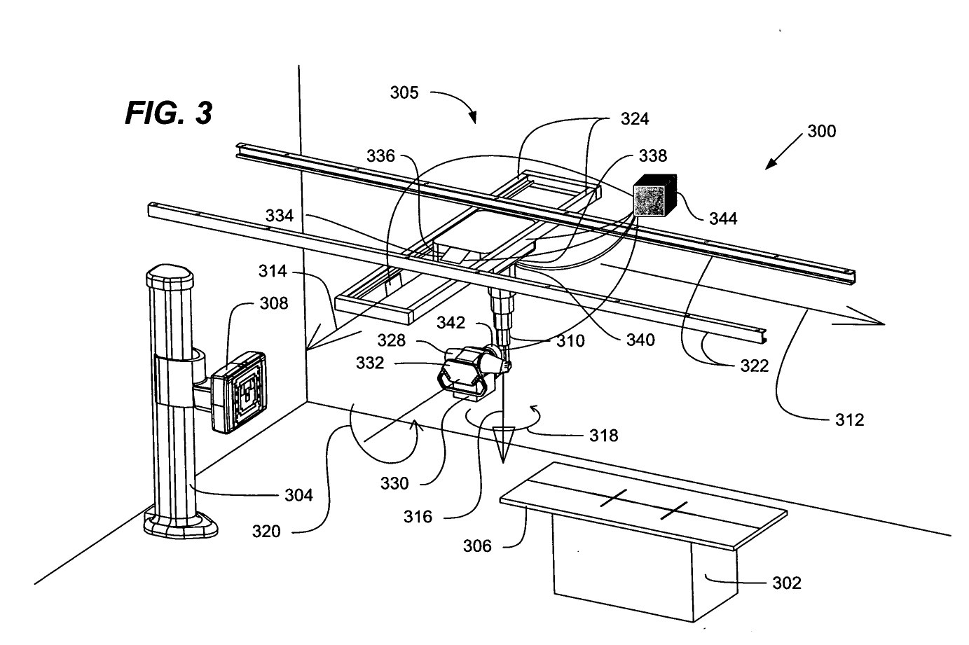

FIG. 3 is a diagram illustrating a system-level overview of an exemplary embodiment of a radiographic system 300. System 300 includes a radiographic table 302 and/or a radiographic wall stand 304, and a radiographic positioning system 305. The radiographic table 302 and the wall stand 304 each contain an image receptor, 306 and 308, respectively.

An overhead tube support (OTS) 310 for performing diagnostic imaging procedures is also included. The OTS 310 provides three linear motions (longitudinal X 312, lateral Y 314 and vertical Z 316) which are perpendicular to each other, and two rotational rotations (rotation about the vertical axis “a” 318, and rotation about one horizontal axis “b” 330).

Longitudinal positioning rails 322 are mounted to a ceiling (not shown). Lateral positioning rails 334 move along the longitudinal positioning rails 322 in the longitudinal X 313 motion. In other embodiments, the lateral positioning rails 334 are mounted to a ceiling and the longitudinal positioning rails 322 move along the lateral positioning rails 334 in the lateral Y 314 motion.

A carriage 336 moves along lateral positioning rails 334 in the lateral Y 314 motion. The OTS 310 is mounted on the carriage 336. A tube mount assembly 322 includes an X-ray source 338 and collimator 330. The tube mount assembly 322 is mounted to the OTS 310. The tube mount assembly 322 and/or the OTS 310 rotate about the vertical “a” 318 axis and the vertical “b” 330 axis.

The OTS 310 can be positioned at any attitude and position within the reaches of radiographic system 300. This flexibility in positioning is important in achieving alignment of the OTS 310 to an image receptor for imaging of a subject that is positioned on the radiographic table 302 or the radiographic wall stand 304. The alignment of the OTS 310 with an image receptor may be directed and/or controlled automatically by a control unit 344 or the alignment may be directed and/or controlled manually.

The lateral positioning rails 334 are operably coupled to the longitudinal positioning rails through one or more first motorized drives 334. The carriage 336 is operably coupled to the lateral positioning rails 334 through one or more second motorized drives 336. In some embodiments, the OTS 310 is operably coupled to the carriage 336 through one or more third motorized drives 338 that rotates the OTS about the vertical Z 316. In some embodiments, the OTS 310 is also operably coupled to the carriage 336 through one or more fourth motorized drives 340 that extend the OTS along the vertical Z 316. In some embodiments, the X-ray source 338 is operably coupled to the OTS 310 through one or more fifth motorized drives 343 that rotate the X-ray source 338 about the horizontal axis “b” 330.

Each motorized drive includes a motor, and a position feedback measuring device, and in some embodiments a clutch and/or a lock or a brake. Each position feedback measuring device further includes a potentiometer, an encoder, a resolver, or a similar device. In the embodiments that lack a clutch, an efficient motor (having high quality bearings and high quality gears) is directly coupled, so that in manual motion the operator causes rotation of the motor armature as well as the OTS.

A control unit 344 is operably coupled to the one or more first motorized drives 334, the one or more second motorized drives 336, the one or more third motorized drives 338, the one or more fourth motorized drives 340 and the one or more fifth motorized drives 343. The control unit 344 controls operation of the motorized drives, which positions the X-ray source 338 and collimator 330 into alignment with a radiographic receptor 306 or 308. The safety switch can be directly connected through a dedicated line or wireless channel to the control unit 344 so as to allow activation or deactivation of the motorized drives.

In some implementations, more than one control unit 344 is included in system 300. Each control unit controls one or more motorized drives 334, 336, 338, 340 and/or 342. For example, in one implementation system 300 includes one control unit for each motorized drive. Each control unit communicates with the other control units, directly, or through other computers.

The control unit 344 improves the accuracy of positioning of the apparatus 338 and 330. The control unit 344 also maintains proper alignment of the apparatus 338 and 330 with the radiographic image receptors 306 and 308 over the full range of travel of the apparatus 338 and 330. The control unit 344 also provides an ability to correct for imperfections in geometry in the apparatus and to allow for greater tolerance in precision in manufacturing and installation. The control unit 344 also reduces confusion of the operator in the relationship between the function of the switches and the motion of the OTS because the positioning of the apparatus 338 and 330 is performed by the control unit 344.

The system level overview of the operation of an embodiment has been described in this section of the detailed description. A control unit 344 controls the motorized drives to position an X-ray source of apparatus 338 and a collimator of apparatus 330 into alignment with a radiographic receptor 306 or 308.

While the system 300 is not limited to any particular radiographic table 302, radiographic wall stand 304, image receptors 306 and 308, OTS 310, longitudinal positioning rails 332, lateral positioning rails 334, carriage 336, X-ray source 338, collimator 330, or control unit 344. For sake of clarity, a simplified radiographic table 303, radiographic wall stand 304, image receptors 306 and 308, OTS 310, longitudinal positioning rails 333, lateral positioning rails 334, carriage 336, X-ray source 338, collimator 330, and control unit 344 have been described.

The system level overview of the operation of an embodiment is described above in this section of the detailed description. Some embodiments operate in a multi-processing, multi-threaded operating environment on a workstation, such as workstation 102 in FIG. 2.

In the previous section, a system level overview of the operation of an embodiment is described. In this section, the particular methods of such an embodiment are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 400 is performed by a program executing on, or performed by firmware or hardware that is a part of, a computer, such as workstation 102 of FIG. 1.

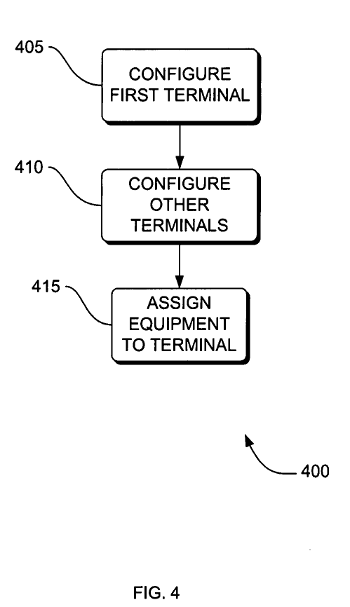

FIG. 4 is a flowchart of a method 400 for configuring terminals, according to an embodiment. Method 400 solves the need in the art solves the need in the art for flexible workflow processing.

Method 400 includes configuration of a first terminal 405, configuration of other terminals 410, and assignment of auxiliary imaging equipment.

The imaging system 200 usually has the information available on scheduled list of patients received from the HIS database 250 and the prescribed scans. In a high throughput medical facility the number of patients to be scanned would be in the order of 15-20 patients per hour and most of this patients will already be waiting for their turn. A large amount of time is spent in positioning the patient and the imaging chain to conform to the required anatomy/view protocols. This is usually done prior to the x-raying of the patients.

Lets say that the imaging system 200 supports the following auxiliary imaging components: x-ray generator (Gen) with one or more tube support say Tube1, Tube2; one or more Overhead tube suspension, OTS1, OTS2 holding Tube1 and Tube2

multiple receptors—Fixed/stretcher Table, one or more wallstand, one or more portable/wireless detectors; room layout configuration—in sectioning out the room layout; a host processor or workstation 102 computing system and acquisition terminal terminals (105, 110, 115) allowing selection of multiple patients at any given time; an allocation protocol that allows x-rays to be generated on available tubes based on user selection; one or more exposure switches available to take x-rays at the selected image chain; access control mechanism to allow exclusive x-ray generation control at either image chain, if simultaneous x-ray not possible.

System can be partitioned into multiple subsections: Chain1—consisting of terminal 105, Gen, OTS1-Tube1, Fixed Table; Chain2: consisting of Gen, terminal 105, OTS2-Tube2, Wallstand, etcetera; Chain2 consisting of terminal 110, Gen OTS2-Tube2, Wallstand and stretcher table. In case of single tube, the Chain1 and Chain2 share the OTS-Tube between them.

In many cases, the patients may only need x-ray scans in either table or WS. In some cases they may need scans on Table and WS. In the second situation, having a stretcher table & fixed table and portable receptors will suffice for image acquisition.

The partitions the room into multiple sections that can be used independent of each other. So in one of the ways that the partitioning can be done with distribution of the auxiliary imaging equipment: Section 1 or room partition 1 Consisting of Fixed Table & WS1 & OTS1; Section 2 or room partition 2—Consisting of Stretcher Table & WS2 & OTS2. The room sections could be physically isolated for privacy reasons by using barriers or screens.

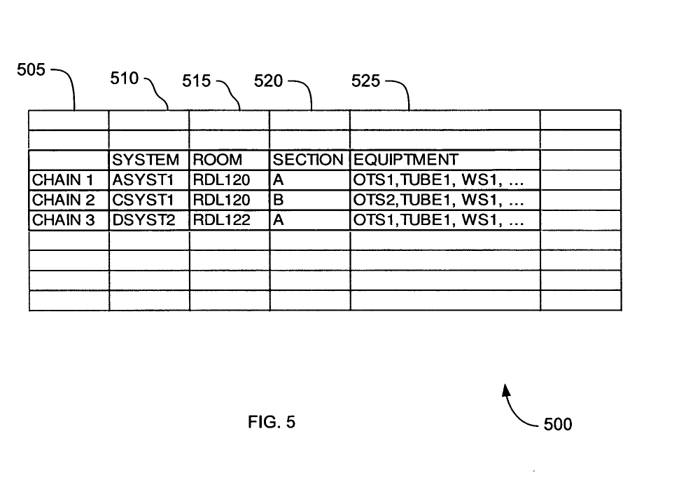

FIG. 5 is a data structure showing the image acquisition chain 505, terminal assigned to the chain 510, and room 515 assigned to the chain, and if the room can be partitioned the section assigned to the chain 520, and the auxiliary equipment assigned to the chain 525. Further, note that if the terminal is not assigned the role of image acquisition then it would not be assigned to a chain and it is most likely performing foreground application processing or accessing archived images.

In some embodiments, methods 400 is implemented as a computer data signal embodied in a carrier wave, that represents a sequence of instructions which, when executed by a processor, such as processor found in workstation 102, cause the processor to perform the respective method. In other embodiments, method 400 is implemented as a computer-accessible medium having executable instructions capable of directing a processor to perform the respective method. In varying embodiments, the medium is a magnetic medium, an electronic medium, or an optical medium.

### CONCLUSION

A method and imaging system for flexible workflow processing is described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application is meant to include all database and communication environments and alternate technologies which provide the same functionality as described herein.

I claim:

1. An imaging system for flexible workflow processing, the imaging system comprising:
an allocation protocol means for configuring an imaging system into subsections; and
an assigning means for assigning one or more terminal to an allocated subsection for performing image acquisition and foreground application processing.

2. The system of claim 1, the system further comprising:
auxiliary imaging equipment usable in combination with assigned terminals for performing image acquisition.

3. The system of claim 2, the system further comprising:
partitioning means for partitioning a room holding the auxiliary image equipment into multiple sections.

4. The system of claim 3, wherein the allocation protocol means further comprises:
chain means for grouping assigned terminals, multiple sections, and the auxiliary imaging equipment into imaging chains for performing image acquisition.

5. The system of claim 3, the system further comprising:
network device for communicating with one or more picture archiving communication system (PACS), hospital information system (HIS), and radiology information system (RIS).

6. The system of claim 5, wherein the hospital information system (HIS) sends a patient list, imaging prescriptions for each patient on the patient list, and recommended auxiliary imaging equipment.

7. The system of claim 6, wherein an operator through a user interface selects or adds the patient to be imaged and selects the imaging chain for the selected or added patient;
wherein a terminal is assigned to a subsection based on the prescription associated with the selected patient.

8. The system of claim 7, wherein the system tracks and captures audit data for each of the assigned terminals and users of the assigned terminals.

9. A method for flexible workflow processing, the method comprising:
configuring an imaging system into subsections;
assigning one or more terminal to a configured subsection for performing image acquisition and foreground application processing.

10. The method of claim 9, the method further comprising:
partitioning a room holding the auxiliary image equipment into multiple sections when the sections are independent of each other;
providing auxiliary imaging equipment usable in combination with assigned terminals for performing image acquisition.

11. The method of claim 10, wherein the assigning further comprises:
grouping assigned terminals, multiple sections, and the provided auxiliary imaging equipment into imaging chains for performing image acquisition.

12. The method of claim 10, the method further comprising:
communicating with one or more picture archiving communication system (PACS), hospital information system (HIS), and radiology information system (RIS).

13. The method of claim 11, wherein the hospital information system (HIS) sends a patient list, imaging prescriptions for each patient on the patient list, and recommended auxiliary imaging equipment.

14. The method of claim 12, wherein an operator through a user interface selects or adds the patient to be imaged and selects the imaging chain for the selected or added patient;
wherein a terminal is assigned to a subsection based on the prescription associated with the selected patient.

15. The method of claim 13, the method further comprising:
tracking and capturing audit data for each of the assigned terminals and users of the assigned terminals.

16. A system for flexible workflow processing comprising:
a first terminal with a user interface configured to perform image acquisition;
one or more additional terminal with a user interface configured to perform foreground application processing; and
a workstation coupled to the first terminal and the one or more additional terminal.

17. The system of claim 16, the system further comprising:
software means operative on the workstation for:
assigning auxiliary imaging equipment to said first terminal for performing image acquisition; and
partitioning a room holding the auxiliary image equipment into multiple sections.

18. The system of claim 17, wherein the system further comprises:
software means operative on the workstation for:
grouping the first terminal, multiple sections, and the auxiliary imaging equipment into imaging chains for performing image acquisition.

19. The system of claim 18, wherein the first terminal and the one or more additional terminal are coupled to one or more picture archiving communication system (PACS), hospital information system (HIS), and radiology information system (RIS).

20. The system of claim 19, wherein the hospital information system (HIS) sends a patient list, imaging prescriptions for each patient on the patient list, and recommended auxiliary imaging equipment.

21. The system of claim 20, wherein an operator through the user interface selects or adds the patient to be imaged and selects the imaging chain for the selected or added patient.

22. The system of claim 21, the system further comprising:
software means operative on the first terminal and the one or more additional terminal for:
tracking and capturing audit data for each users of the first terminal and the one or more additional terminal.
